(19) United States
(12) Patent Application Publication
(10) Pub. No.: US 2025/0333257 A1
(43) Pub. Date: Oct. 30, 2025

(54) GUIDE-EQUIPPED BELT

(71) Applicant: NITTA CORPORATION, Osaka (JP)

(72) Inventors: Hiroaki TAJIMA, Yamatokoriyama-shi (JP); Hiroyuki TANIYA, Yamatokoriyama-shi (JP); Shinji FURUKI, Yamatokoriyama-shi (JP); Koichi ARAI, Yamatokoriyama-shi (JP); Yuki SATO, Yamatokoriyama-shi (JP)

(21) Appl. No.: 19/187,136

(22) Filed: Apr. 23, 2025

(30) Foreign Application Priority Data
Apr. 26, 2024 (JP) 2024-073251

(51) Int. Cl. B65H 5/02; D04B 1/10; D04B 1/18; F16G 1/28

(52) U.S. Cl. CPC B65H 5/021; D04B 1/102; D04B 1/18; B65H 2404/22; B65H 2404/27; B65H 2404/40; D10B 2401/061; D10B 2505/00; F16G 1/28

(57) ABSTRACT

A guide-equipped belt includes: a flat belt portion; a guide portion that is made of an elastic material and protrudes along a longitudinal direction on a surface of the flat belt portion face to a pulley; and a guide covering material that is made of a knitted fabric, includes a dense mesh such that the guide covering material is not embedded in the elastic material constituting the guide portion, and covers a surface of the guide portion, in which at a top portion of the guide portion where the guide covering material is exposed to an outside, a recess gently inclined from corners of the top portion to a center of the top portion is formed along the longitudinal direction.

### CROSS REFERENCE TO RELATED APPLICATIONS

This application claims the benefit of foreign priority to Japanese Patent Application No. 2024-073251, filed on Apr. 26, 2024, which is incorporated by reference in its entirety. The present invention relates to a guide-equipped belt.

### BACKGROUND ART

### Technical Field

In general, a flat belt having a flat conveyance surface is used as a conveyance belt used in a conveyor that conveys paper sheets (for example, print sheets) or the like. Since contact of a flat belt with a conveyance object is surface contact, the flat belt can stably convey the conveyance object. However, there is a problem that the flat belt meanders during running and comes off a pulley.

To prevent the conveyance belt from meandering, a method is known in which a guide is provided on a side of a flat belt face to a pulley, and the guide is fitted into a guide groove of the pulley and is driven.

Patent Literature 1 discloses a meandering prevention protrusion-equipped conveyor belt (guide-equipped belt) in which a protrusion of a silicone elastomer is provided as a guide portion on a core of the conveyor belt, and the guide portion is covered with an elastic fabric. Patent Literature 1 discloses a configuration in which the elastic fabric is used as a guide covering material, and a guide portion is covered with the guide covering material, thereby preventing wear on the guide portion by the guide covering material. In Patent Literature 1, a guide-equipped belt is manufactured by feeding an elastic fabric, which is the guide covering material, while discharging a molten elastic material that constitutes the guide portion, moving a roller from above the guide covering material while pressing the roller, and leaving the guide-equipped belt at room temperature to cure.

### CITATION LIST

### Patent Literature

Patent Literature 1: JPH07-2329A

### SUMMARY OF INVENTION

### Technical Problem

In Patent Literature 1, since the guide covering material is also fed while the molten elastic material is discharged and the guide covering material is pressed by the roller, the molten elastic material exudes through a mesh of the guide covering material, resulting in a portion where the guide covering material is embedded in the guide portion. Therefore, in the related art, since there is a portion where the guide covering material is embedded and is not covered with the guide covering material in the guide portion, there is a problem that it is insufficient to prevent wear on the guide portion and reduce a friction coefficient by the guide covering material.

Further, in a case in which an attachment operation of fitting the guide portion into the guide groove of the pulley or a detachment operation of detaching the guide portion fitted into the guide groove from the guide groove is performed, since a surface of the guide portion is covered with the guide covering material, the guide portion is less likely to be deformed, and thus a burden on the attachment and detachment operations may increase.

The present invention has been made in view of the above problems, and an object thereof is to provide a guide-equipped belt capable of preventing wear on a guide portion, reducing a friction coefficient, and reducing a burden on attachment and detachment operations.

### Solution to Problem

The guide-equipped belt according to the present invention includes: a flat belt portion; a guide portion that is made of an elastic material and protrudes along a longitudinal direction on a surface of the flat belt portion face to a pulley; and a guide covering material that is made of a knitted fabric, includes a dense mesh such that the guide covering material is not embedded in the elastic material constituting the guide portion, and covers a surface of the guide portion, in which at a top portion of the guide portion where the guide covering material is exposed to an outside, a recess gently inclined from corners of the top portion to a center of the top portion is formed along the longitudinal direction.

### Advantageous Effects of Invention

According to the present invention, by covering the guide portion with the guide covering material that includes a dense mesh such that the guide covering material is not embedded in the elastic material constituting the guide portion, the elastic material of the guide portion is prevented from exuding through the mesh of the guide covering material in a manufacturing process, and thus the surface of the guide portion can be covered without the guide covering material being embedded in the guide portion. Therefore, since the guide covering material is exposed from the surface of the guide portion, wear on the guide portion can be prevented by the guide covering material as compared with that in the related art. Further, by using the guide covering material that includes the dense mesh such that the guide covering material is not embedded in the elastic material constituting the guide portion, the recess can be formed at the top portion of the guide portion. Therefore, since the guide portion is likely to be deformed by the recess, a burden on attachment and detachment operations can be reduced.

### BRIEF DESCRIPTION OF DRAWINGS

FIG. 1 is a cross-sectional view of a guide-equipped belt according to an embodiment.

FIG. 2 is a plan view of a guide covering material constituting the guide-equipped belt in FIG. 1 and a schematic diagram illustrating an example of a mesh configuration of the guide covering material.

FIG. 3 is a schematic diagram illustrating a method of manufacturing the guide-equipped belt according to the embodiment.

FIG. 4 is a cross-sectional view illustrating the method of manufacturing the guide-equipped belt according to the embodiment.

FIG. 5 is a cross-sectional view illustrating a process after FIG. 4.

### DESCRIPTION OF EMBODIMENTS

Hereinafter, an embodiment of the present invention will be described in detail with reference to the drawings. In the following description, the same components are denoted by the same reference numerals, and redundant descriptions will be omitted.

### (1) Overall Configuration of Guide-Equipped Belt 1

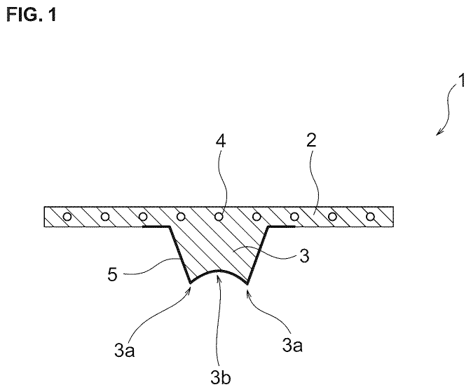

FIG. 1 is a cross-sectional view of a guide-equipped belt 1 according to an embodiment. The guide-equipped belt 1 includes: a flat belt portion 2; a guide portion 3 that is made of an elastic material and protrudes along a longitudinal direction on a surface of the flat belt portion 2 face to a pulley; and a guide covering material 5 that is made of a knitted fabric, includes a dense mesh such that the guide covering material 5 is not embedded in the elastic material constituting the guide portion 3, and covers a surface of the guide portion 3, in which at a top portion of the guide portion 3 where the guide covering material 5 is exposed to an outside, a recess 3b gently inclined from corners 3a of the top portion to a center of the top portion is formed along the longitudinal direction.

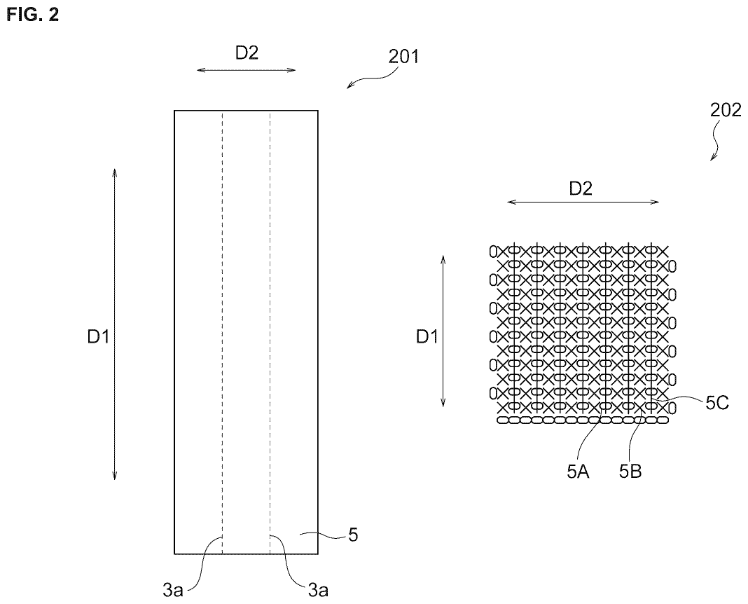

201 in FIG. 2 is a plan view of the guide covering material 5 constituting the guide-equipped belt 1 according to the present embodiment. The guide covering material 5 has a shape extending in a longitudinal direction D1 along the guide portion 3. A direction orthogonal to the longitudinal direction D1 is a width direction D2 of the guide covering material 5. In 201 in FIG. 2, positions of the corners 3a of the top portion of the guide portion 3 are indicated by dotted lines. The guide covering material 5 is formed to cover the entire guide portion 3 including the corners 3a of the top portion of the guide portion 3.

It is preferable that the guide covering material 5 includes the dense mesh such that, when the molten elastic material constituting the guide portion 3 and the guide covering material 5 are adhered to each other in a manufacturing process, the molten elastic material does not exude through the guide covering material 5 to the outside, and the guide covering material 5 is not embedded in the guide portion 3.

The guide covering material 5 preferably has an elongation percentage of 10% or more in the longitudinal direction and 20% or more in the width direction when measured with a load of 19 N using a sample having a width of 40 mm in a measurement method according to JISL1096, and for example, the guide covering material 5 has an elasticity of 10% or more in the longitudinal direction D1 when measured with the sample having a width of 40 mm. In a case in which the elongation percentage of the guide covering material 5, particularly the elongation percentage thereof in the longitudinal direction, is insufficient, the guide portion 3 has a crushed shape, resulting in a guide molding failure. This may also lead to poor adhesion between the guide portion 3 and the guide covering material 5, causing the guide covering material 5 to peel off. However, since the elongation percentage of the guide covering material 5 in the longitudinal direction is 10% or more, peeling can be prevented. The elongation percentage of the guide covering material 5 is preferably 70% or more in the longitudinal direction.

202 in FIG. 2 is a schematic diagram illustrating an example of a mesh (weave pattern) configuration of the guide covering material 5. In 202 in FIG. 2, symbol 5A indicates a chain yarn that constitutes a chain stitch, symbol 5B indicates a weft insertion yarn, and symbol 5C indicates a warp insertion yarn. The weft insertion yarn is inserted to connect a loop portion of the chain stitch in a weft direction. The warp insertion yarn is inserted to connect the loop portion of the chain stitch in a warp direction.

The guide covering material 5 may include a yarn other than the elastic yarn. For example, as the chain yarn indicated by the symbol 5A and the weft insertion yarn indicated by the symbol 5B, resin fibers such as PA66 or other polyamides can be used.

The guide portion 3 is used by being fitted into a guide groove of the pulley, and has a function as a guide for preventing meandering of the guide-equipped belt 1. In the guide portion 3, a recess 3b gently inclined from the corners 3a of the top portion to the center of the top portion is provided along the longitudinal direction at the top portion of the guide portion 3. Since the recess 3b is provided at the top portion of the guide portion 3 along the longitudinal direction, the corners 3a of the top portion of the guide portion 3 can be easily deformed toward the center, thereby releasing a pressure applied to the guide portion 3 when the guide-equipped belt 1 is in use, and facilitating the guide portion 3 to be detached from the guide groove.

As the elastic material constituting the flat belt portion 2 and the guide portion 3, various known elastic materials that can be used as the guide-equipped belt 1 can be used, and for example, one or more of rubber, synthetic resin, thermoplastic elastomer can be used. Examples of the rubber include natural rubber, isoprene rubber, butadiene rubber, styrene butadiene rubber, ethylene propylene rubber, chloroprene rubber, chlorinated polyethylene, epichlorohydrin rubber, nitrile rubber, acrylic rubber, urethane rubber, and hydrogenated nitrile butadiene rubber (H-NBR). Examples of the synthetic resin include polyurethane, polyvinyl chloride, polycarbonate, polyester, polyarylate, styrene-butadiene copolymer, styrene-acrylonitrile copolymer, acrylic copolymer, styrene-acrylic acid copolymer, polyethylene, ethylene-vinyl acetate copolymer, chlorinated polyethylene, polypropylene, vinyl chloride-vinyl acetate copolymer, alkyd resin, polyamide, polysulfone, diallyl phthalate resin, ketone resin, polyvinyl acetal, and polyether. Examples of the thermoplastic elastomer include a polyester-based elastomer, a polyamide-based elastomer, and a polyolefin-based elastomer. In particular, the guide-equipped belt 1 is preferably molded from one or more selected from polyurethane, polyvinyl chloride, polyester-based elastomer, polyamide-based elastomer, and polyolefin-based elastomer.

A plurality of core wires 4 are embedded in the flat belt portion 2 along the longitudinal direction of the guide-equipped belt 1. Accordingly, rigidity of the guide-equipped belt 1 in the longitudinal direction can be increased. As a material of the core wire 4, various known materials that can be used as a core wire can be used, and examples thereof include those obtained by forming a metal wire, a polyester cord, a polyamide cord, a glass cord, aramid, rayon, or the like into a thread shape, a fiber shape, or the like. Further, the number of the core wires 4 is not particularly limited, and may be selected as desired according to a required conveyance force.

The core wires 4 aligned in the longitudinal direction of the guide-equipped belt 1 may be uniformly embedded inside the flat belt portion 2 over the width direction of the guide-equipped belt 1, or may be embedded such that either a central portion or both side edge portions are dense. A shape of the core wire 4 is not particularly limited, and the core wire 4 may be a sheet-shaped fabric (woven fabric) or braided fabric made of the above aramid or the like.

The guide-equipped belt 1 preferably has an endless shape with both ends joined together. Accordingly, the guide-equipped belt 1 can be tensioned between the pulleys and convey a conveyance object. Joining of both ends is not particularly limited, and examples thereof include joining by thermal fusion and joining by an adhesive.

### (2) Method of Manufacturing Guide-Equipped Belt 1

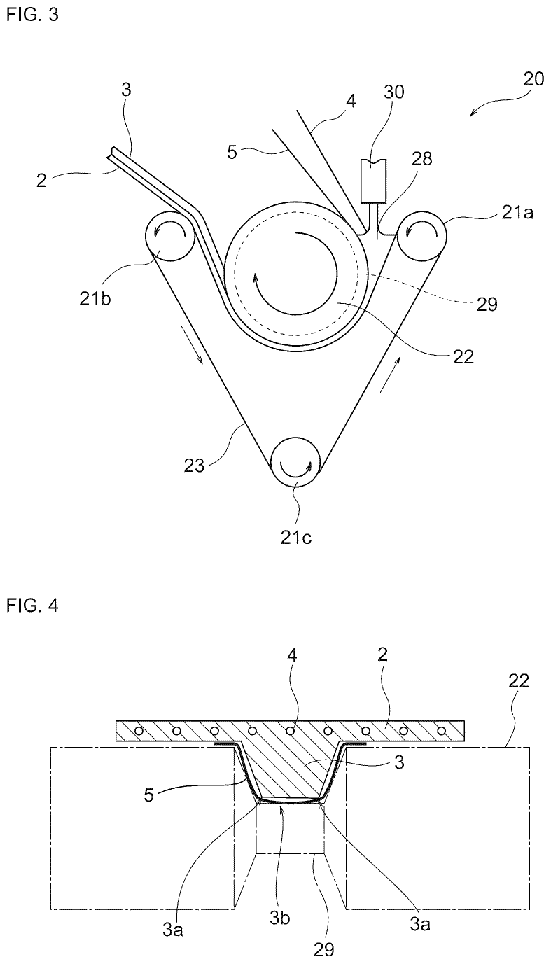

Next, a method of manufacturing the guide-equipped belt 1 according to the present embodiment will be described in detail with reference to the drawings. FIG. 3 is a schematic diagram illustrating the method of manufacturing the guide-equipped belt 1 according to the present embodiment.

As illustrated in FIG. 3, a guide-equipped belt manufacturing apparatus 20 includes pulleys 21a, 21b, and 21c, a guide portion molding pulley 22 disposed between the pulleys 21a and 21b, and a belt 23 tensioned by the pulleys 21a, 21b, and 21c and the pulley 22.

Here, the belt 23 is pressed against the pulley 22 by the pulley 21b when not in use, and when in use, with an elastic material 28 in a molten state poured between the pulley 22 and the belt 23, the elastic material is sandwiched between the pulley 22 and the belt 23, thereby maintaining a certain distance (distance corresponding to a thickness of the flat belt portion 2). Further, a groove portion 29 having a shape corresponding to the guide portion 3 of the guide-equipped belt 1 is formed in a substantially central portion of the guide portion molding pulley 22 along a circumferential direction of the pulley 22.

Then, the elastic material 28 in the molten state is continuously poured from an injection nozzle 30 while continuously inserting the core wire 4 and the guide covering material 5 between the pulley 21a and the guide portion molding pulley 22.

In this state, by rotating the belt 23 and the pulley 22 in the arrow directions, the elastic material 28 is cooled and solidified while the pulley 22 rotates about half a turn, and the guide-equipped belt 1 including the flat belt portion 2 with the core wire 4 embedded inside and the guide portion 3 whose surface is covered with the guide covering material 5 is manufactured from between the pulley 21b and the pulley 22.

FIG. 4 is a cross-sectional view illustrating the method of manufacturing the guide-equipped belt 1 according to the present embodiment. The guide-equipped belt 1, in which the flat belt portion 2 with the core wire 4 embedded inside, and the guide portion 3 whose surface is covered with the guide covering material 5 are integrally molded are integrally molded by the groove portion 29 of the pulley 22, is manufactured.

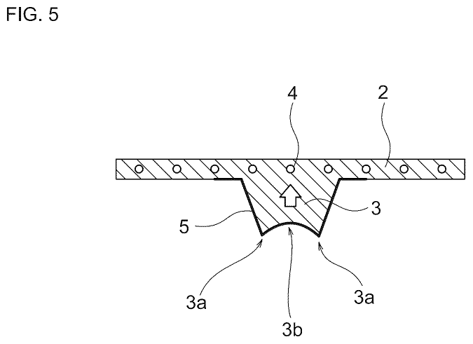

FIG. 5 is a cross-sectional view illustrating a process after FIG. 4. Immediately after molding by the groove portion 29 of the pulley 22, as illustrated in FIG. 4, the top portion of the guide portion 3 has a flat shape in which no recess is formed. However, when the elastic material is further cooled, the elastic material contracts, and as illustrated in FIG. 5, the top portion of the guide portion 3 has a shape in which the recess 3b gently inclined from the corners 3a of the top portion to the center of the top portion is provided along the longitudinal direction.

As the guide covering material 5, it is preferable to use a material including a dense mesh such that, when the molten elastic material constituting the guide portion 3 and the guide covering material 5 are adhered to each other in the above manufacturing process, the molten elastic material does not exude through the guide covering material 5 to the outside, and the guide covering material 5 is not embedded in the guide portion 3.

### (3) Operation and Effect of Guide-Equipped Belt

According to the above configuration, in the guide-equipped belt 1, the surface of the guide portion 3 is covered with the guide covering material 5 that is made of the knitted fabric, includes the dense mesh such that the guide covering material 5 is not embedded in the elastic material constituting the guide portion 3. Further, in the guide-equipped belt 1, at the top portion of the guide portion 3 where the guide covering material 5 is exposed to the outside, the recess 3b gently inclined from the corners 3a of the top portion to the center of the top portion is formed along the longitudinal direction.

As described above, in the guide-equipped belt 1, by covering the guide portion 3 with the guide covering material 5 that includes the dense mesh such that the guide covering material 5 is not embedded in the elastic material constituting the guide portion 3, the elastic material of the guide portion 3 is prevented from exuding through the mesh of the guide covering material 5 in the manufacturing process, and thus the surface of the guide portion 3 can be covered without the guide covering material 5 being embedded in the guide portion 3. Therefore, since the guide covering material 5 is exposed from the surface of the guide portion 3, wear on the guide portion 3 can be prevented by the guide covering material 5 as compared with that in the related art, and a friction coefficient of the guide portion 3 can be reduced. Further, in the guide-equipped belt 1, by using the guide covering material 5 that includes the dense mesh such that the guide covering material 5 is not embedded in the elastic material constituting the guide portion 3, the recess 3b can be formed along the longitudinal direction, at the top portion of the guide portion 3 in the manufacturing process. Therefore, since the guide portion 3 is likely to be deformed by the recess 3b, a burden on attachment and detachment operations can be reduced.

The guide portion 3 is fitted into the guide groove of the pulley, and in this state, the guide-equipped belt 1 runs. Since the guide portion 3 is integrally molded with the flat belt portion 2, peeling of the guide portion 3 from the flat belt portion 2 is prevented, and the guide-equipped belt 1 can exhibit high running stability and conveyance capability over a long period of time.

By covering the guide portion 3 with the guide covering material 5, a sliding resistance between the guide and the guide groove can be prevented, and both conveyance of a heavy object and reduction of a load on a machine due to a magnitude of an axial load can be achieved.

When the guide covering material 5 is made of a high-density knitted fabric, exudation of an adhesive and guide material resin can be prevented, and an increase in sliding resistance and an accompanying increase in load on a motor can be prevented.

### (4) Applications

The guide-equipped belt 1 of the present invention is used in a conveyor such as a printer or a copier that conveys a paper sheet (for example, print sheets) or the like by sandwiching the paper sheet or the like between two belts from above and below, and can reliably convey these conveyance objects. Further, the conveyor in which the guide-equipped belt 1 of the present invention is used is not limited to the conveyor described above, and for example, the guide-equipped belt 1 can also be used as a belt of a conveyor for conveying a paper sheet (for example, a bill) in a financial institution, a conveyor for conveying a thin steel plate, a cardboard, or the like, or a conveyor in precision equipment, food or game equipment, a machine tool, or the like. Further, the guide-equipped belt 1 may be used for driving.

### (5) Other Embodiments

The present invention is not limited to the above embodiment, and can be appropriately modified without departing from the gist of the present invention. For example, one guide portion 3 protrudes along the longitudinal direction at a substantially central portion of the surface of the flat belt portion 2 face to the pulley. However, positions and the number of protruding guide portions 3 can be selected as desired depending on a width of the flat belt portion 2 or the pulleys to be combined. For example, when the width of the flat belt portion 2 is wide, a plurality of guide portions 3 may protrude from the flat belt portion 2. In this case, it is preferable that at least one guide portion 3 protrudes from each of both end portions of the flat belt portion 2. Further, a plurality of guide portions 3 may be adjacent to a substantially central portion of the flat belt portion 2.

### REFERENCE SIGN LIST

1 guide-equipped belt
2 flat belt portion
3 guide portion
3a corner of top portion
3b recess
4 core wire
5 guide covering material

1. A guide-equipped belt comprising:
a flat belt portion;
a guide portion that is made of an elastic material and protrudes along a longitudinal direction on a surface of the flat belt portion face to a pulley; and
a guide covering material that is made of a knitted fabric, includes a dense mesh such that the guide covering material is not embedded in the elastic material constituting the guide portion, and covers a surface of the guide portion, wherein
at a top portion of the guide portion where the guide covering material is exposed to an outside, a recess gently inclined from corners of the top portion to a center of the top portion is formed along the longitudinal direction.

2. The guide-equipped belt according to claim 1, wherein
the guide covering material includes a chain yarn that constitutes a chain stitch, a weft insertion yarn that connects a loop portion of the chain stitch of the chain yarn in a weft direction, and a warp insertion yarn that connects the loop portion of the chain stitch of the chain yarn in a warp direction.

3. The guide-equipped belt according to claim 1, wherein
the guide covering material includes the dense mesh such that, when the molten elastic material constituting the guide portion and the guide covering material are adhered to each other in a manufacturing process, the molten elastic material does not exude through the guide covering material to the outside, and the guide covering material is not embedded in the guide portion.

4. The guide-equipped belt according to claim 1, wherein
the guide covering material has an elongation percentage of 10% or more when measured with a sample having a width of 40 mm.

5. The guide-equipped belt according to claim 4, wherein
the guide covering material has an elasticity of 10% or more in the longitudinal direction when measured with the sample having a width of 40 mm.

6. The guide-equipped belt according to claim 1, wherein
the guide covering material includes an elastic yarn.

7. The guide-equipped belt according to claim 1, wherein
a core wire or a fabric is embedded inside the flat belt portion.
